(19) United States
(12) Patent Application Publication
(10) Pub. No.: US 2019/0220930 A1
(43) Pub. Date: Jul. 18, 2019

(54) USAGE BASED INSURANCE COMPANION SYSTEM

(71) Applicant: Ford Global Technologies, LLC, Dearborn, MI (US)

(72) Inventors: Karl Nathan CLARK, Belleville, MI (US); Tracy S. PARKS, Commerce Twp., MI (US)

(21) Appl. No.: 15/869,776

(22) Filed: Jan. 12, 2018

(51) Int. Cl. G06Q 40/08; B60Q 9/00; B60W 40/09; G08B 21/02

(52) U.S. Cl. CPC G06Q 40/08; B60Q 9/00; G05D 1/021; G08B 21/02; B60W 40/09

(57) ABSTRACT

An autonomous vehicle system may include a memory that maintains a library associating an insurance policy with a user; and a controller, coupled to the memory, programmed to receive vehicle data indicative of driving habits of the user, determine whether the driving habits comply with at least one factor required by the policy; and instruct an adjustment of an autonomous vehicle component associated by the library with the factor to aid in compliance with the policy.

### TECHNICAL FIELD

Disclosed herein are usage based insurance companion systems.

### BACKGROUND

Insurance companies may use various mechanisms to determine costs of vehicle insurance. These mechanisms may include various driver records such as those acquired from a motor vehicle agency. Insurance companies may also acquire vehicle data indicative of a customer's driving habits. Insurance companies may offer customers the opportunity to receive discounts based on the customer's driving habits.

### SUMMARY

An autonomous vehicle system may include a memory that maintains a library associating an insurance policy with a user; and a controller, coupled to the memory, programmed to receive vehicle data indicative of driving habits of the user, determine whether the driving habits comply with at least one factor required by the policy, and instruct an adjustment of an autonomous vehicle component associated by the library with the factor to aid in compliance with the policy.

A usage based insurance system for a vehicle may include a memory configured to maintain a library associating at least one insurance policy with a user and defining at least one driving behavior factor and an autonomous vehicle component related therewith, a controller coupled to the memory and programmed to receive vehicle data indicative of driving habits of a user, determine whether the driving habits comply with the factor required by the policy, and instruct an adjustment of the vehicle component related to the factor by the library to aid in compliance with the policy.

A method for affecting an autonomous vehicle component to comply with an insurance policy requirement may include receiving vehicle data indicative of driving habits of a user, determining whether the driving habits comply with at least one factor required by an insurance policy, and affecting an autonomous vehicle component related to the factor to aid in compliance with the insurance policy.

### BRIEF DESCRIPTION OF THE DRAWINGS

The embodiments of the present disclosure are pointed out with particularity in the appended claims. However, other features of the various embodiments will become more apparent and will be best understood by referring to the following detailed description in conjunction with the accompanying drawings in which:

FIG. 1 illustrates an example diagram of a system configured to provide telematics services to a vehicle;

FIG. 2 illustrates an example block diagram of a usage based insurance (UBI) system;

FIG. 3 illustrates an example UBI library of the UBI system; and

FIG. 4 illustrates an example process for the UBI system.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

Disclosed herein is a usage based insurance (UBI) system that collects and prepares vehicle data and compares the driving habits reflected in this data with requirements set forth by a specific insurance policy. The UBI system helps customers achieve a “safe driver” status in order to qualify for certain auto insurance discounts by affecting certain autonomous vehicle systems in a way that forces the vehicle to perform according to the requirements. The system has the ability to support UBI criteria and factors across multiple insurance policies and agencies and affect only those systems and driving habits necessary to achieve a certain status for a specific policy.

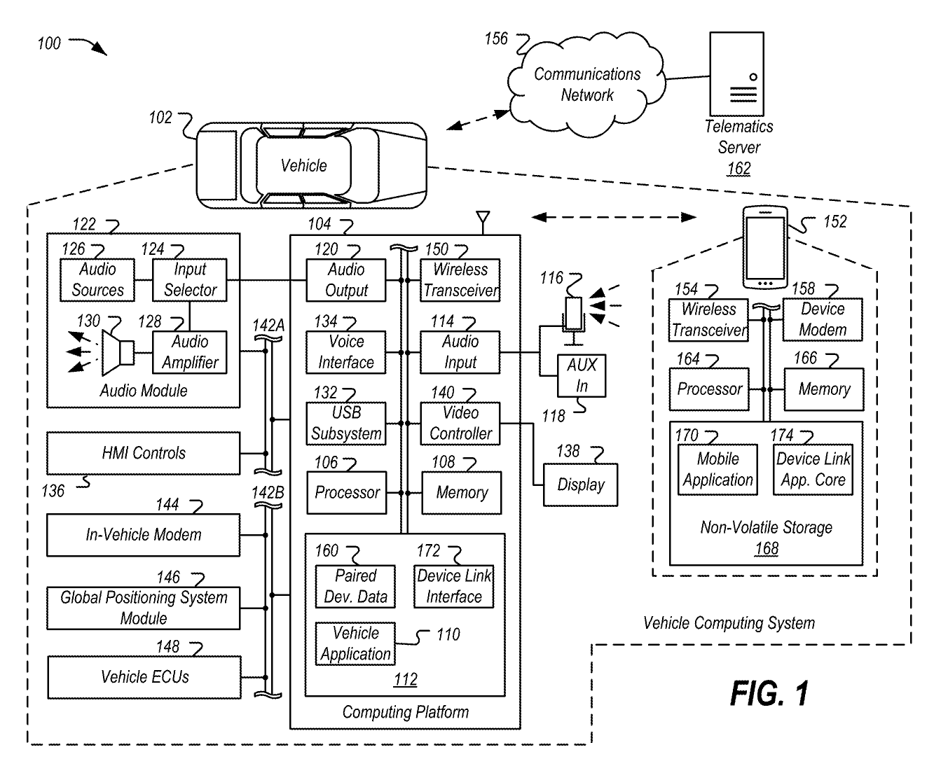

FIG. 1 illustrates an example diagram of a system 100 configured to provide telematics services to a vehicle 102. The vehicle 102 may include various types of passenger vehicle, such as crossover utility vehicle (CUV), sport utility vehicle (SUV), truck, recreational vehicle (RV), boat, plane or other mobile machine for transporting people or goods. Telematics services may include, as some non-limiting possibilities, navigation, turn-by-turn directions, vehicle health reports, local business search, accident reporting, and hands-free calling. In an example, the system 100 may include the SYNC system manufactured by The Ford Motor Company of Dearborn, MI. It should be noted that the illustrated system 100 is merely an example, and more, fewer, and/or differently located elements may be used.

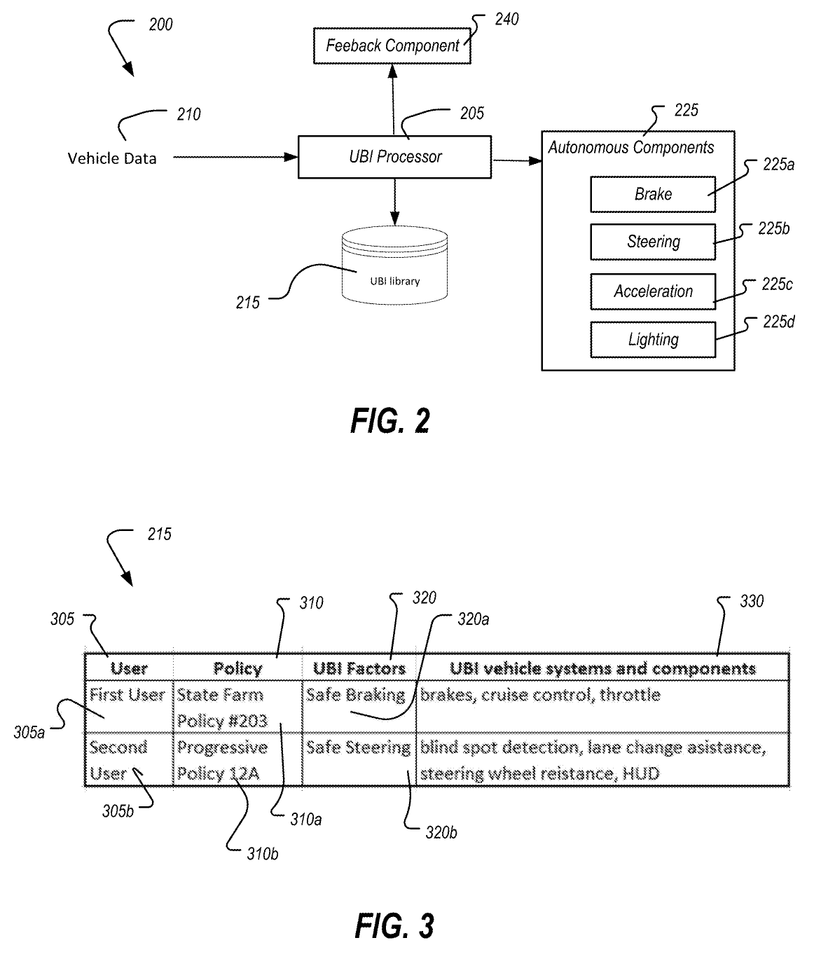

The computing platform 104 may include a memory 108 and one or more processors 106 configured to perform instructions, commands and other routines in support of the processes described herein. For instance, the computing platform 104 may be configured to execute instructions of vehicle applications 110 to provide features such as navigation, accident reporting, satellite radio decoding, and hands-free calling. These instructions may include execution of a usage based insurance system 200 as described in more detail with respect to FIG. 2 below. Such instructions and other data may be maintained in a non-volatile manner using a variety of types of computer-readable storage medium 112. The computer-readable medium 112 (also referred to as a processor-readable medium or storage) includes any non-transitory medium (e.g., a tangible medium) that participates in providing instructions or other data that may be read by the processor 106 of the computing platform 104. Computer-executable instructions may be compiled or interpreted from computer programs created using a variety of programming languages and/or technologies, including, without limitation, and either alone or in combination, Java, C, C++, C#, Objective C, Fortran, Pascal, Java Script, Python, Perl, and PL/SQL.

The computing platform 104 may be provided with various features allowing the vehicle occupants to interface with the computing platform 104. For example, the computing platform 104 may include an audio input 114 configured to receive spoken commands from vehicle occupants through a connected microphone 116, and auxiliary audio input 118 configured to receive audio signals from connected devices. The auxiliary audio input 118 may be a physical connection, such as an electrical wire or a fiber optic cable, or a wireless input, such as a BLUETOOTH audio connection. In some examples, the audio input 114 may be configured to provide audio processing capabilities, such as pre-amplification of low-level signals, and conversion of analog inputs into digital data for processing by the processor 106.

The computing platform 104 may also provide one or more audio outputs 120 to an input of an audio module 122 having audio playback functionality. In other examples, the computing platform 104 may provide the audio output to an occupant through use of one or more dedicated speakers (not illustrated). The audio module 122 may include an input selector 124 configured to provide audio content from a selected audio source 126 to an audio amplifier 128 for playback through vehicle speakers 130 or headphones (not illustrated). The audio sources 126 may include, as some examples, decoded amplitude modulated (AM) or frequency modulated (FM) radio signals, and audio signals from compact disc (CD) or digital versatile disk (DVD) audio playback. The audio sources 126 may also include audio received from the computing platform 104, such as audio content generated by the computing platform 104, audio content decoded from flash memory drives connected to a universal serial bus (USB) subsystem 132 of the computing platform 104, and audio content passed through the computing platform 104 from the auxiliary audio input 118.

The computing platform 104 may utilize a voice interface 134 to provide a hands-free interface to the computing platform 104. The voice interface 134 may support speech recognition from audio received via the microphone 116 according to a standard grammar describing available command functions, and voice prompt generation for output via the audio module 122. The voice interface 134 may utilize probabilistic voice recognition techniques using the standard grammar 176 in comparison to the input speech. In many cases, the voice interface 134 may include a standard user profile tuning for use by the voice recognition functions to allow the voice recognition to be tuned to provide good results on average, resulting in positive experiences for the maximum number of initial users. In some cases, the system may be configured to temporarily mute or otherwise override the audio source specified by the input selector 124 when an audio prompt is ready for presentation by the computing platform 104 and another audio source 126 is selected for playback.

The computing platform 104 may also receive input from human-machine interface (HMI) controls 136 configured to provide for occupant interaction with the vehicle 102. For instance, the computing platform 104 may interface with one or more buttons or other HMI controls configured to invoke functions on the computing platform 104 (e.g., steering wheel audio buttons, a push-to-talk button, instrument panel controls, etc.). The computing platform 104 may also drive or otherwise communicate with one or more displays 138 configured to provide visual output to vehicle occupants by way of a video controller 140. In some cases, the display 138 may be a touch screen further configured to receive user touch input via the video controller 140, while in other cases the display 138 may be a display only, without touch input capabilities.

The computing platform 104 may be further configured to communicate with other components of the vehicle 102 via one or more in-vehicle networks 142. The in-vehicle networks 142 may include one or more of a vehicle controller area network (CAN), an Ethernet network, and a media oriented system transfer (MOST), as some examples. The in-vehicle networks 142 may allow the computing platform 104 to communicate with other vehicle 102 systems, such as a vehicle modem 144 (which may not be present in some configurations), a global positioning system (GPS) module 146 configured to provide current vehicle 102 location and heading information, and various vehicle ECUs 148 configured to communicate with the computing platform 104. As some non-limiting possibilities, the vehicle ECUs 148 may include a powertrain control module configured to provide control of engine operating components (e.g., idle control components, fuel delivery components, emissions control components, etc.) and monitoring of engine operating components (e.g., status of engine diagnostic codes); a body control module configured to manage various power control functions such as exterior lighting, interior lighting, keyless entry, remote start, and point of access status verification (e.g., closure status of the hood, doors and/or trunk of the vehicle 102); a radio transceiver module configured to communicate with key fobs or other local vehicle 102 devices; and a climate control management module configured to provide control and monitoring of heating and cooling system components (e.g., compressor clutch and blower fan control, temperature sensor information, etc.).

As shown, the audio module 122 and the HMI controls 136 may communicate with the computing platform 104 over a first in-vehicle network 142-A, and the vehicle modem 144, GPS module 146, and vehicle ECUs 148 may communicate with the computing platform 104 over a second in-vehicle network 142-B. In other examples, the computing platform 104 may be connected to more or fewer in-vehicle networks 142. Additionally or alternately, one or more HMI controls 136 or other components may be connected to the computing platform 104 via different in-vehicle networks 142 than shown, or directly without connection to an in-vehicle network 142.

The computing platform 104 may also be configured to communicate with mobile devices 152 of the vehicle occupants. The mobile devices 152 may be any of various types of portable computing device, such as cellular phones, tablet computers, smart watches, laptop computers, portable music players, or other devices capable of communication with the computing platform 104. In many examples, the computing platform 104 may include a wireless transceiver 150 (e.g., a BLUETOOTH module, a ZIGBEE transceiver, a Wi-Fi transceiver, an IrDA transceiver, an RFID transceiver, etc.) configured to communicate with a compatible wireless transceiver 154 of the mobile device 152. Additionally or alternately, the computing platform 104 may communicate with the mobile device 152 over a wired connection, such as via a USB connection between the mobile device 152 and the USB subsystem 132. In some examples, the mobile device 152 may be battery powered, while in other cases the mobile device 152 may receive at least a portion of its power from the vehicle 102 via the wired connection.

The communications network 156 may provide communications services, such as packet-switched network services (e.g., Internet access, VoIP communication services), to devices connected to the communications network 156. An example of a communications network 156 may include a cellular telephone network. Mobile devices 152 may provide network connectivity to the communications network 156 via a device modem 158 of the mobile device 152. To facilitate the communications over the communications network 156, mobile devices 152 may be associated with unique device identifiers (e.g., mobile device numbers (MDNs), Internet protocol (IP) addresses, etc.) to identify the communications of the mobile devices 152 over the communications network 156. In some cases, occupants of the vehicle 102 or devices having permission to connect to the computing platform 104 may be identified by the computing platform 104 according to paired device data 160 maintained in the storage medium 112. The paired device data 160 may indicate, for example, the unique device identifiers of mobile devices 152 previously paired with the computing platform 104 of the vehicle 102, such that the computing platform 104 may automatically reconnected to the mobile devices 152 referenced in the paired device data 160 without user intervention.

When a mobile device 152 that supports network connectivity is paired with the computing platform 104, the mobile device 152 may allow the computing platform 104 to use the network connectivity of the device modem 158 to communicate over the communications network 156 with the remote telematics server 162 or other remote computing device. In one example, the computing platform 104 may utilize a data-over-voice plan or data plan of the mobile device 152 to communicate information between the computing platform 104 and the communications network 156. Additionally or alternately, the computing platform 104 may utilize the vehicle modem 144 to communicate information between the computing platform 104 and the communications network 156, without use of the communications facilities of the mobile device 152.

Similar to the computing platform 104, the mobile device 152 may include one or more processors 164 configured to execute instructions of mobile applications 170 loaded to a memory 166 of the mobile device 152 from storage medium 168 of the mobile device 152. In some examples, the mobile applications 170 may be configured to communicate with the computing platform 104 via the wireless transceiver 154 and with the remote telematics server 162 or other network services via the device modem 158.

For instance, the computing platform 104 may include a device link interface 172 to facilitate the integration of functionality of the mobile applications 170 configured to communicate with a device link application core 174 executed by the mobile device 152. In some examples, the mobile applications 170 that support communication with the device link interface 172 may statically link to or otherwise incorporate the functionality of the device link application core 174 into the binary of the mobile application 170. In other examples, the mobile applications 170 that support communication with the device link interface 172 may access an application programming interface (API) of a shared or separate device link application core 174 to facilitate communication with the device link interface 172.

The integration of functionality provided by the device link interface may include, as an example, the ability of mobile applications 170 executed by the mobile device 152 to incorporate additional voice commands into the grammar of commands available via the voice interface 134. The device link interface 172 may also provide the mobile applications 170 with access to vehicle information available to the computing platform 104 via the in-vehicle networks 142. An example of a device link interface 172 may be the SYNC APPLINK component of the SYNC system provided by the Ford Motor Company of Dearborn, MI. Other examples of device link interfaces 172 may include MIRRORLINK, APPLE CARPLAY, and ANDROID AUTO.

FIG. 2 illustrates an example block diagram of a usage based insurance (UBI) system 200. The usage based insurance system 200 may be configured to affect certain autonomous vehicle features in order to encourage a driver to comply with UBI criteria. By complying with the UBI criteria, the user may receive certain rewards such as discounts or incentives on his or her insurance rates. For example, the UBI system 200 may affect the braking system of a vehicle to prevent harsh braking, which may have a negative effect on UBI rates.

The UBI system 200 may include a UBI processor 205 configured to receive vehicle data 210 from one or more vehicle systems or databases. The vehicle data 210 may include collected vehicle data 210 that reflects a user's driving behavior. For example, the vehicle data 210 may include braking data or a rate of braking, speed data, miles driven, use of safety equipment such as seat belts and turn signals, types of roads driven, time of day of driving, among other data. This data may be acquired by monitoring various vehicle components such as powertrain components, tire RPM, transmission settings, throttle positions, turn signal indicator, ignition status, airbag sensors, brake sensors, odometer reading, cruise control settings and application, GPS data, external cameras, ultrasonic parking sensors, among others.

The vehicle ECUs 148 and storage medium 112, as well as the GPS module 146 may provide the vehicle data 210. The communications network 156 may also provide all or part of the vehicle data 210, as well as other components, including the mobile device 152.

The UBI processor 205 may be included in the processor 106 or may be a separate controller. The UBI processor 205 may be included in the communications network 156, or another device such as the mobile device 152. The UBI processor 205 may be configured to carry out the methods and processes described herein.

The UBI system 200 may include a UBI library 215. The UBI library 215 may be a library included in the storage medium 112, or may be stored elsewhere, including on the mobile device 152 and/or a device in communication via the communication network 156.

Referring to FIG. 3, the UBI library 215 may maintain a look-up table or database of insurance policies 310 associated with a specific user 305. The UBI processor 205 may receive the vehicle data 210, which may include the user 305. The user 305 may be identified via any of several mechanisms, including a unique user ID associated with a key-fob used to gain access to the vehicle. The user may also be identified by his or her mobile device 152 and a unique identifier used in pairing with the vehicle 102. Each user may be associated with a specific insurance policy 310.

A first user 305a may carry auto insurance under a certain provider and have a certain policy type. For example, the first user 305a may carry STATE FARM auto insurance, the policy type being one having a reward program for which the user may appreciate certain monetary discounts in response to having certain driving habits. The second user 305b may have Progressive™ auto insurance with a similar policy and discount program. However, the discount programs may have certain factors that affect the rewards and discounts. For example, driving the speed limit may be one factor that affects the discount. Other examples include appropriate braking, appropriate steering, etc. The factors may vary from policy to policy. One policy may provide discounts for safe braking, while another may provide discounts for safe steering. Because each policy is different, a user may not necessarily know which driving habits affect the possibility for discounts.

The UBI library 215 may outline various policies 310. Each policy 310 may be associated with one or more factors 320. A factor 320 is a category of driving habits measured according to driver input to the vehicle, where compliance with the factor 320 affects the driver's eligibility to the discount program of the user's policy 210. For example, a first policy 310a may require a safe braking factor 320a. The safe braking factor 320a may require that the user not harshly brake during driving, have a low rate of braking, have a low number of braking situations, etc. The factors 320 may further include one or more thresholds that relate to the driving habits to determine conformance with the respective factor 320. For instance, the safe braking factor 320a may include a maximum threshold number of brake incidents that are allowable within a predefined period of time.

The factors 320 may be associated with a relevant vehicle system or component 330 relating to achieving that factor 320. For example, in order to aid the driver in achieving a discount under the first policy 310a, the UBI processor 205 may determine which vehicle components 330 may affect harsh braking. These components may be associated with the policy 310a in the UBI library 215. For example, for the first policy 310a having a safe braking factor 320a, the associated vehicle components 330a may be the vehicle brakes, cruise control, and throttle, for example. For the second policy 310b having a safe steering factor 320b, the associated vehicle components 330b may be blind spot detection system, lane change assistance system, steering wheel resistance, and heads-up-display, for example.

The UBI processor 205 may use the UBI library 215 to look up the policy 310 for the specific driver/user. The UBI processor 205 may then look up the vehicle components 330 that may affect the policy's factors 320. The UBI processor 205, in response to realizing the relevant and associated factors 320 may in turn provide instructions to those autonomous components in an effort to obviate any driving habits that could negatively affect the factors 330 required in order to receive a discount.

Returning to FIG. 2, the UBI system 200 may include various autonomous components that affect the factors 330 outlined in the UBI library 215. The autonomous components 225 may include components capable of being controlled for autonomous purposes such as hands-free driving, etc. The autonomous components 225 may include a braking component 225a, a steering component 225b, an acceleration component 225c, and a lighting component 225d.

The UBI processor 205 may provide instruction to the autonomous components 255 in order to aid the driver in meeting or exceeding the factors 320 outlined in the associated insurance policy 310. The UBI processor 205 may evaluate the vehicle data 210 to determine whether the driving habits of the driver are currently in violation of one or more of the factors 320 for that driver's insurance policy. In response to a violation, the UBI processor 205 may instruct the autonomous component 225 to adjust or react or perform in a certain way so as to increase the likelihood that the driver complies with the factor 320 and therefore receives discounts on his or her auto insurance.

The brake component 225a may include components that control braking of the vehicle 102. This may include the vehicle brakes, cruise control systems, etc. The UBI processor 205 may leverage functionality of these components to ensure the braking criteria outlined in the brake factor 320a can be met. For example, the UBI processor 205 may affect an application of the brakes upon determining that the vehicle 102 is approaching a stop sign. By affecting the brakes, the chance of the user harshly braking to come to a stop would be diminished. In one example, the brakes may be activated when a stop sign is encountered or detected. In another example, active cruise control may be enabled if it is detected that the driver is accelerating or braking too harshly. In another example, the brakes may be activated in response to the approach of an emergency vehicle. Such indications may be transmitted via the network 152, as well as vehicle-to-vehicle communications. Additionally, the navigation module may indicate that a harsh brake may be necessary in order for the vehicle to reach their intended destination.

The steering component 225b may include all components that control steering of the vehicle 102. This may include vehicle steering wheel and column, parking aid systems, lane change assistance, etc. The UBI processor 205 may leverage blind spot detection and lane changing assistance to provide steering wheel resistance where necessary to help prevent vehicle collisions.

The acceleration component 225c may include all components that control the speed of the vehicle. For example, this may include the cruise control systems, the throttle, accelerometer, etc. In response to the UBI library 215 having a speed factor associated with a certain insurance policy, the UBI processor 205 may control the speed of the vehicle to comply with those factors. In one example, the speed is controlled to maintain the vehicle 102 within a certain threshold of the speed limit.

The lighting component 225d may include a component relating to lighting of the vehicle, both interior and/or exterior. For example, in response to the UBI having a safety factor that may be based on the user of the lighting component under certain circumstances. For example, exterior headlights should be on at night. Daytime running lights should be on when driving in certain jurisdictions, such as Canada. In the event of an emergency, such as a flat tire or accident, hazard lights should be on.

The UBI system 200 may also include one or more feedback components 240. These feedback components 240 may be components within the vehicle 102 to provide feedback to the driver that the autonomous components 225 are being leveraged in order to aid the driver in complying with the factors 320. By providing such feedback, the driver may begin to adjust his or her driving habits in an effort to render the leveraging by the autonomous components 225 unnecessary.

The feedback components 240 may include audible components such as vehicle speakers. The speakers may provide a chime or other audible indication that control assistance has been provided in response to the UBI factors 320. The feedback components 240 may include a visual component such as heads-up display, a center console display, etc. This display may blink, light up, display textual indications of the control assistance.

The feedback components 240 may also include a haptic component configured to provide haptic feedback. In one example, the haptic component may be arranged in a vehicle seat and may vibrate in response to control assistance.

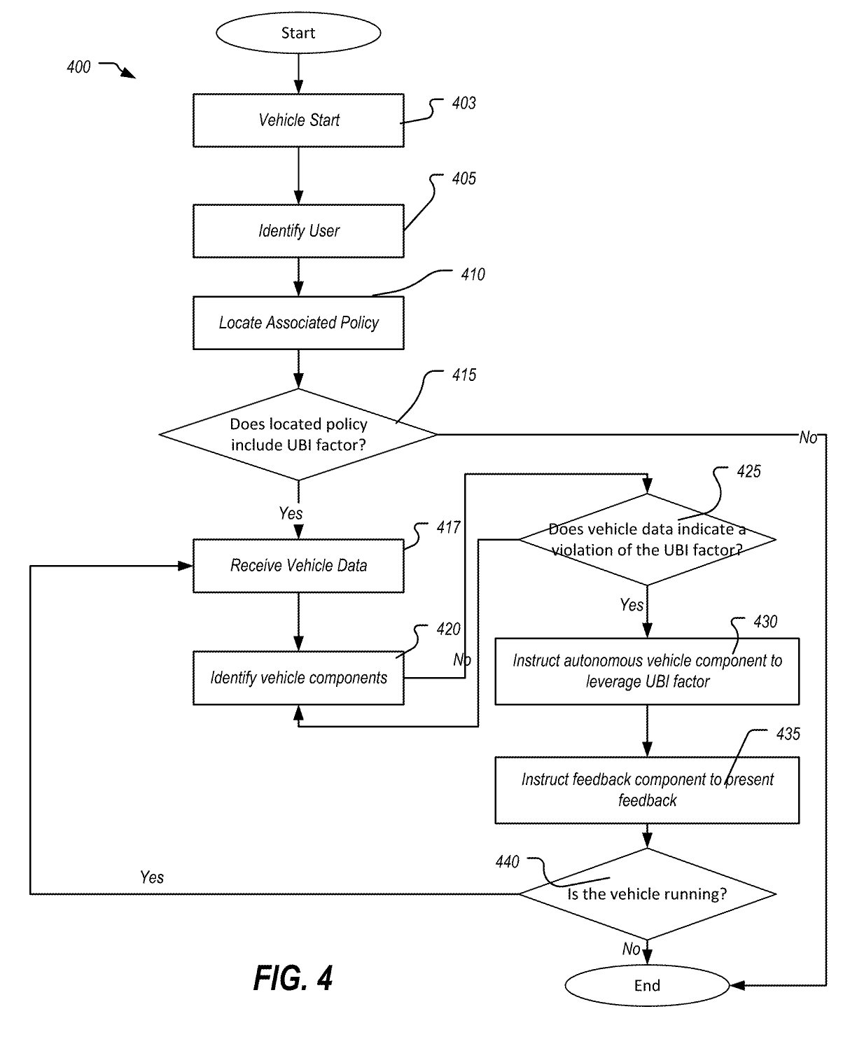

FIG. 4 illustrates an example process 400 for the UBI system 200. The process 400 begins at block 403 responsive to occurrence of a vehicle start. The vehicle start may include a keyed or keyless start.

At block 405 the UBI processor 205 may identify the user 305. As explained above, the user 305 may be identified by the key fob, the user's phone, etc. In some examples, the UBI processor 205 may default to a certain user that typically drives the vehicle 102.

At block 410, the UBI processor 205 may locate an associated insurance policy via the UBI library 215 for the identified user 305.

At block 415, the UBI processor 205 may determine whether a UBI factor 320 is associated with the located policy 310. If so, the process 400 may proceed to block 417. If not, the process 400 may end.

At block 417, the UBI processor 205 may receive the vehicle data 210. As explained above, the vehicle data 210 may include data that reflects a user's driving behavior such as braking, acceleration, seat belt usage, etc.

At block 420, the UBI processor 205 may identify the one or more vehicle components 330 associated with the insurance policy 310.

At block 425, the UBI processor 205 may determine whether the vehicle data 210 indicates a violation of the UBI factor 320. For example, the UBI processor 205 may determine whether the vehicle is traveling at a speed in excess of that allowed by the UBI factor 320. If the vehicle data 210 indicates a driving behavior that is in violation of the factor 320, the process 400 proceeds to block 430. If not, the process 400 returns to block 420.

At block 430, the UBI processor 205 may instruct at least one autonomous vehicle component 225 to leverage the UBI factor 320. As explained above, this may include instructing the brakes of the vehicle 102 to perform a certain way, or the steering components to restrict certain movement of the vehicle 102.

At block 435, the UBI processor 205 may instruct one of the feedback components to present feedback to the driver that the UBI processor 205 has leveraged a vehicle system to comply with the UBI factor 320 of the insurance policy. As explained above, this may include a haptic, visual, or audible feedback in order to inform the driver that he or she has driving habits outside of those encouraged by the insurance policy 310.

At block 440, the UBI processor 205 may determine whether the vehicle 102 is running. A vehicle status, such as whether it is running, may be included in the vehicle data 210 or acquired from other vehicle components. If the vehicle is running, the process 400 proceeds back to block 417. If not, the process 400 ends.

Computing devices described herein, such as the computing platform 104, mobile device 152, and telematics server 162, generally include computer-executable instructions where the instructions may be executable by one or more computing devices such as those listed above. Computer-executable instructions, such as those of the virtual network interface application 202 or virtual network mobile application 208, may be compiled or interpreted from computer programs created using a variety of programming languages and/or technologies, including, without limitation, and either alone or in combination, Java™, C, C++, C#, Visual Basic, JavaScript, Python, JavaScript, Perl, PL/SQL, Prolog, LISP, Corelet, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their broadest reasonable constructions and their ordinary meanings as understood by those knowledgeable in the technologies described herein unless an explicit indication to the contrary in made herein. In particular, use of the singular articles such as “a,” “the,” “said,” etc. should be read to recite one or more of the indicated elements unless a claim recites an explicit limitation to the contrary.

The abstract of the disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. An autonomous vehicle system, comprising:
a memory that maintains a library associating an insurance policy with a user; and
a controller, coupled to the memory, programmed to
receive vehicle data indicative of driving habits of the user;
determine whether the driving habits comply with at least one factor required by the policy; and
instruct an adjustment of an autonomous vehicle component associated by the library with the factor to aid in compliance with the policy.

2. The system of claim 1, wherein the controller is further programmed to identify the autonomous vehicle component based on the policy and the factor, and control the autonomous vehicle component to affect compliance with the factor responsive to the identification.

3. The system of claim 1, wherein one of the at least one factor is associated with a reward to users, and the controller is further configured to determine whether the insurance policy includes the at least one factor associated with the reward.

4. The system of claim 1, further comprising a feedback component configured to present feedback to a driver indicative of activation of the adjustment in response to the driving habits failing to comply with the at least one factor.

5. The system of claim 4, wherein the feedback component provides at least one of a visual, audible, or haptic alert.

6. The system of claim 1, wherein the vehicle component is one of a brake, steering, or acceleration component configured to affect the driving behavior.

7. The system of claim 1, wherein the factor includes one or more thresholds relating to driving habits defined by the vehicle data, wherein determining whether the driving habits comply with the factor required by the policy includes comparing the driving habits with the threshold.

8. A usage based insurance system for a vehicle, comprising:
a memory configured to maintain a library associating at least one insurance policy with a user and defining at least one driving behavior factor and an autonomous vehicle component related therewith;
a controller coupled to the memory and programmed to:
receive vehicle data indicative of driving habits of a user;
determine whether the driving habits comply with the factor required by the policy; and
instruct an adjustment of the vehicle component related to the factor by the library to aid in compliance with the policy.

9. The system of claim 8, wherein the controller is further programmed to identify the autonomous vehicle component based on the policy and the factor, and control the autonomous vehicle component to affect compliance with the factor responsive to the identification.

10. The system of claim 8, wherein one of the at least one factor is associated with a reward to users, and the controller is further configured to determine whether the insurance policy includes the at least one factor associated with the reward.

11. The system of claim 8, further comprising a feedback component configured to present feedback to a driver indicative of activation of the adjustment on an autonomous vehicle component in response to the driving habits failing to comply with the at least one factor.

12. The system of claim 9, wherein the feedback component provides at least one of a visual, audible, or haptic alert.

13. The system of claim 8, wherein the vehicle component is one of a brake, steering and acceleration component configured to affect the driving behavior.

14. A method for affecting an autonomous vehicle component to comply with an insurance policy requirement, comprising:
receiving vehicle data indicative of driving habits of a user;
determining whether the driving habits comply with at least one factor required by an insurance policy; and
adjusting an autonomous vehicle component related to the factor to aid in compliance with the insurance policy.

15. The method of claim 14, further comprising determining the vehicle component based on the policy.

16. The method of claim 1314 further comprising determining whether the insurance policy includes the at least one factor associated a reward to users.

17. The method of claim 14, further comprising presenting feedback to a driver indicative of activation of the autonomous vehicle component in response to the driving habits failing to comply with the at least one factor.

18. The method of claim 17, wherein the feedback provides at least one of a visual, audible, and haptic alert.

19. The method of claim 14, wherein the vehicle component is one of a brake, steering and acceleration component configured to affect the driving behavior.
